(19) United States
(12) Patent Application Publication
(10) Pub. No.: US 2006/0156445 A1
(43) Pub. Date: Jul. 13, 2006

(54) Molecular motor power-supplying device

(75) Inventors: Ming-Jong Wang, Dayuan Township (TW); Hsin-Yun Tsai, Hsinchu (TW)

Correspondence Address: BACON & THOMAS, PLLC, 625 SLATERS LANE, FOURTH FLOOR, ALEXANDRIA, VA, 22314, US

(73) Assignee: Industrial Technology Research Institute, Hsinchu (TW)

(21) Appl. No.: 11/319,078

(22) Filed: Dec. 28, 2005

(30) Foreign Application Priority Data
Jan. 7, 2005 (TW) 094100545

(51) Int. Cl. H02N 3/00; H02K 5/00

(52) U.S. Cl. 977/725; 310/10; 310/40 MM; 977/726

(57) ABSTRACT

A tiny power-assembly device driven by rotatory molecular motors are disclosed. The molecular motor power-supplying device includes multiple connecting members, multiple upper rotating arms, multiple lower rotating arms and multiple rotatory molecular motors. The F₁-ATPase is optioned as the sample molecular motor of this device and is located between the upper rotating arm and the lower rotating arm. Each molecular motor is connected with a lower rotating arm through the α, β subunits and connected with a lower rotating arm by the γ subunit. The molecular motor power-supplying device can be driven to shorter (connecting members closely) or longer (connecting members separated far away) by the accumulated driving forces from the rotatory molecular motors.

### BACKGROUND OF THE INVENTION

1. Field of the Invention

The present invention relates to a tiny power-supplying device which combine the power from many rotatory molecular motors. In particular, the power-supplying device, although that uses rotatory molecular motors, is for outputting power to be a linear (not a rotating) motion device. Moreover, the power-supplying device can also be used as a tiny gate with self-driven power.

2. Description of Related Art

Currently, many researchers pay their attention on the devices of micro/nano-electro-mechanical systems (MEMS/NEMS). As the size of the MEMS/NEMS is minimized, a demand for tiny power-supplying devices in nano scale or micro scale generates. Since there is no adequate power-supplying device of nano-scale or micro-scale, the research of the nano-scaled or micro-scaled system is limited. So far, the modem research of the power-supplying device MENS/NEMS mainly focuses on the bio-motor from living cells or bionic mechanism. For example, the nano bio-motors such as myosin, ATPsynthase can be a potent candidate for the motors used in the artificial nano systems.

However, the bio or bionic motors are about one to ten nanometer scale and the outputted power of single molecule is limited. At the same time, the power or the size of these motors cannot be adjusted conveniently. Hence, the researchers suggested to combine several tiny molecular motors together for increase the outputted power.

Some kinds of power-supplying device made of linear (translational motion) molecular motors such as myosin or kinesin are disclosed so far. Most of these power-supplying device contain multiple plates associated with the linear molecular motors (Japan Patent number 61-135989). Each two plates are driven to move relatively by the concerted movement of many linear molecular motors which are arranged between plates. By increasing the number of the plates, the speed of the outputted (through its top and bottom plates, i.e. two terminal plates) relative movement can be increased. The outputted power (pulling or pushing force) from the terminal plates can be amplified through the concerted movement of all the linear molecular motors. However, the efficient for transferring power of the linear molecular motors is not high in general. Moreover, the thickness of the device also increases as the number of the plates increases. Therefore, the application is limited. In addition, the direction of the outputted power is parallel to the plates. The two ends of the outputted forces are not on the same plane (the two terminal plates are parallel but not on the same plane). Then, the MEMS/NEMS will bear unnecessary torque when they use such power-supplying devices. As the number of plates increase, it will produce more serious problem for that such power-supplying devices will generate more great unnecessary torque.

Therefore, it is desirable to provide an improved molecular motor power-supplying device to mitigate the aforementioned problems.

### SUMMARY OF THE INVENTION

The invention provides a molecular motor power-supplying device which is made of many rotatory (rotating motion) molecular motors. The device contains multiple rigid bars (connecting members). Many rotatory molecular motors are arranged between each two rigid bars. The outputted power accumulated from the molecular motors of this device is transmitted out through two terminal rigid bars of the device. Its output is still the linear force (pulling or pushing force), the same as the device where conventional linear molecular motors are used.

But the direction of outputted power is perpendicular to the rigid bars. Although, the speed of the outputted relative movement can be increased by increasing the number of the rigid bars in this invention, similarly to the increase of the number of the plates in conventional devices. In this invention, there are no problems about the need to take additional unnecessary torque because the two ends of the outputted forces remain in the plane perpendicular to the rigid bars when the number of rigid bars increases.

Not only can offer accumulated power from many molecular motors for the MEMS/NEMS with some function purpose, moreover, the molecular motor power-supplying device of the present invention can be applied as a micro gate with self-driven power. I.e., itself can also be used as an assembly with door function in a system.

The device of this invention includes multiple (at least two) connecting members (rigid bars), multiple upper rotating arms, multiple lower rotating arms and multiple molecular motors. Each two neighboring connecting members can be translated closely or farly away according to the concerted rotation between stators and rotors of the molecular motors such that the pulling or pushing forces accumulated from the contributions of many rotating molecular motors can be outputted through the two terminal connecting members.

In this invention, any rotatory bio or bionic molecular motors are not limited to be used. The F₁-ATPase, a rotatory bio molecular motor, is optioned as a sample to be realized present invention.

Other objects, advantages, and novel features of the invention will become more apparent from the following detailed description when taken in conjunction with the accompanying drawings.

### BRIEF DESCRIPTION OF THE DRAWINGS

FIG. 1 is a schematic view of the molecular motor power-supplying device of the present invention.

FIG. 2 is a schematic view of the molecular motor F₁-ATPase with α subunits, β subunits, and γ subunit.

FIG. 3a -3j are schematic views of the process for manufacturing the molecular motor power-supplying device of the present invention.

FIG. 4a -4b are schematic views for:
a. the contractive motion (pulling force output) of the molecular motor power-supplying device of the present invention;
b. the micro gate with self-driven power of the present invention.

FIG. 5a -5b are schematic views of the combination of the drug delivery vehicle and the molecular motor power-supplying device of the present invention.

### DETAILED DESCRIPTION OF THE PREFERRED EMBODIMENT

With reference to FIG. 4a, the molecular motor power-supplying device (100) includes multiple (at least two) connecting members (10), multiple upper rotating arms (20), multiple lower rotating arms (30), and multiple molecular motors (40).

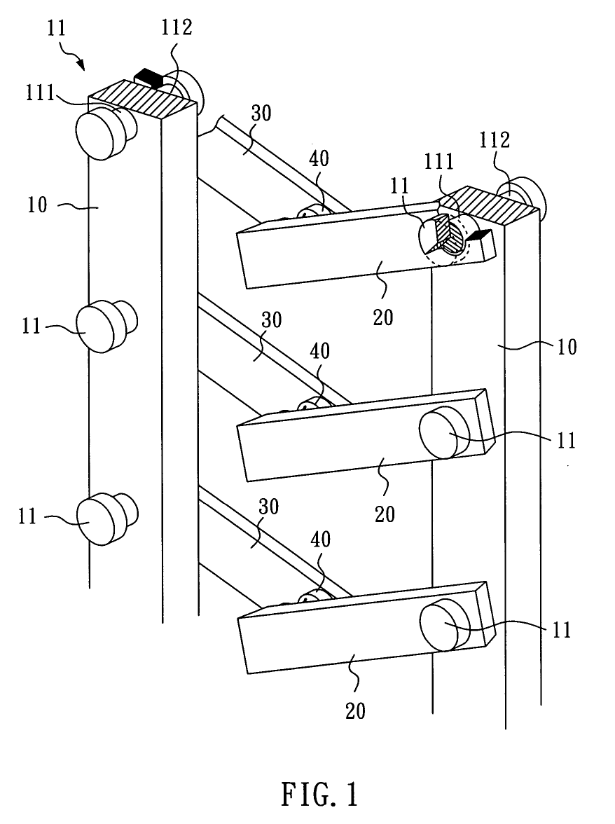

With reference to FIG. 1, the connecting member (10) of the molecular motor power-supplying device are formed with upper pivots (111) and lower pivots (112) on their top and bottom surfaces respectively. The lower pivots (112) and upper pivots (111) are used for the connection of other elements. The molecular motors (40) of the molecular motor power-supplying device are located between any two neighboring connecting members (10). The molecular motors (40) of the molecular motor power-supplying device have a stator and a rotor for achieving relative rotation (the stator and the rotor can rotate each other). Furthermore, one end of the upper rotating arm (20) is pivoted connecting to the upper pivot (111) and able to rotate around the upper pivot (111 ). The other end of the upper rotating arm is securely connected to the rotor of the molecular motor (40). Likewise, one end of the lower rotating arm (30) is pivoted connecting to the lower pivot (112) and able to rotate around the lower pivot (112). The other end of the lower rotating arm (30) is securely connected to the stator of the molecular motors (40).

For those two upper rotating arm (20) and lower rotating arm (30) connected with the same molecular motor (40), once the upper rotating arm (20) is pivoted connecting to and able to rotate relatively to one of the two neighboring connecting members (10), the lower rotating arm (30) must be pivoted connecting to and able to rotate relatively to the other one of the two neighboring connecting members (10). For that we want to use the power of molecular motors (40) to drive the movement of the neighboring connecting members (10). Besides, the connecting members (10) need enough rigidity and strength to take the responsibility of transferring the forces therein.

Thereafter, each two neighboring connecting members (10) can be translationally moved closely or farly away according to the concerted rotation between stators and rotors of the molecular motors (40). And the two terminal (the most left one and the most right one, as shown in FIG. 4a) connecting members (10) can output the assembled power from the contributions of many rotating molecular motors (40). Thus, a molecular motor power-supplying device (100) is formed. This power-supplying device can be used for moving elements of biomedical or micro/nanometer devices.

Of course, as the number of the molecular motors (40) increases, the output power (pulling or pushing force) increases, too. The more of the number of the connecting members is, the faster the relative moving speed of the two terminal connecting members (10) is.

With reference to FIG. 4a and 4b, each neighboring two connecting members (10) can be moved closely or farly away according to the concerted rotation of the molecular motors (40) therein. So that his device can be shortened (connecting members closely ) or lengthened (connecting members separated far away). Hence, it can also be used as a door (micro gate).

Because the structure members, including the connecting members, the upper rotating arms and the lower rotating arms, must be strong and rigid enough to take the forces therein. The connecting members, the upper rotating arms and the lower rotating arms are made of rigid and solid materials. The materials for the connecting members, upper rotating arms and the lower rotating arms can be either metal or non-metallic materials. Preferably, the metal material is aluminum, iron, gold, copper, nickel, or the alloy thereof. On the other hand, the non-metallic material for the connecting members, the upper rotating arms, and the lower rotating arms is preferred to be silicon, poly-silicon, SiO₂ nitride, quartz, polymers, or the combination therof. More preferably, the material for the connecting members, the upper rotating arms, and the lower rotating arms is silicon or poly-silicon.

In this invention, any rotatory bio or bionic molecular motors are not limited to be used. But the followings will only take the F₁-ATPase as a sample to be realized and to complete the description of present invention.

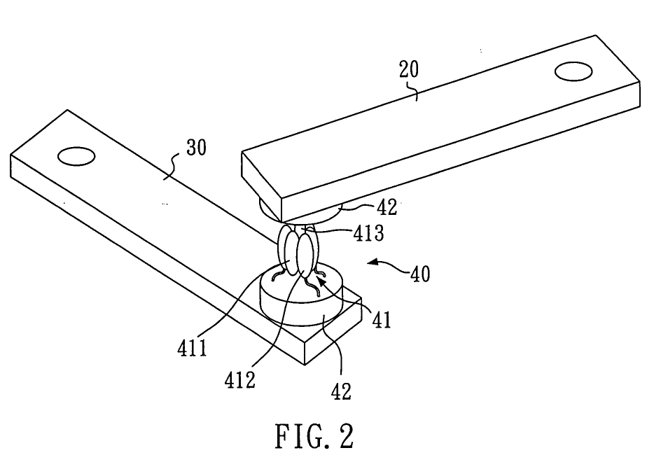

With reference FIG. 2, the F₁-ATPase molecular motor (40) has three α subunits (411), three β subunits (412), and one γ subunit (413), i.e., the α₃β₃γ complex. The γ subunit (413) is the rotor of this molecular motor (40) and the α₃β₃ subunits are the stator of this molecular motor (40). Its size is about 10 nm. This molecular motor can combine with an adenosine triphosphate (ATP, an energy source of this bio-motor). After an ATP is hydrolyzed, the rotor can rotate counterclockwise in an angle of 120 degrees relative to the stator. We can only use this motor as one-direction motor for that its rotating direction is limited in general.

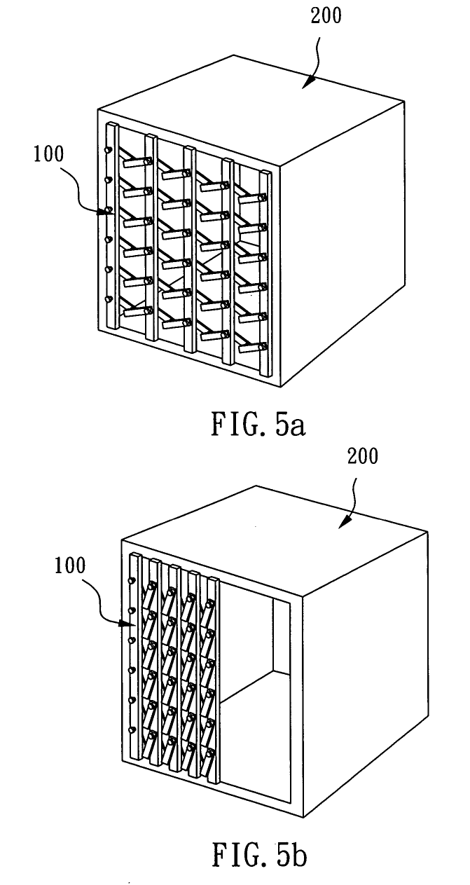

With reference to FIG. 4a, before the molecular motor rotates, the angle between the upper rotating arm and the lower rotating arm is set a little greater than 120 degrees. Then, after an ATP being hydrolyzed within each molecular motor therein, this device can be shortened (closely), causing that those neighboring connecting members are nearly contact (shown as in FIG. 4b) each other. Hence, this device can be used as a pulling force power-supplying device. This can also be used as a door (one-direction micro gate), once the “closing state” of the door having initially set, and may be driven to “opening state” by the molecular motors therein (referring FIG. 5).

In addition, a stator connection site is mounted on the stator and the rotor independently. The stator connection site is connected with one end of the upper rotating arm, and the rotor connection site is connected with one end of the lower rotating arm.

The stator connection site or the rotor connection site can be made by modifying F₁-ATPase through genetic engineering including its DNA mutation and protein expression. The position of the rotor connection site is not limited. Preferably, the rotor connection site is located on the γ subunit of the F₁-ATPase. The position of the stator connection site is not limited. Preferably, the stator connection site is located below the α subunit of the F₁-ATPase, below the β subunit of the F₁-ATPase, or below the combination of the α subunit and the β subunit of the F₁-ATPase. The modification of the stator of the F₁-ATPase through genetic engineering is preferred to introduce multiple Histidines through direct conjugation below the α subunit and the β subunit of the F₁-ATPase. On the other hand, the modification of the rotor of the F₁-ATPase through genetic engineering is preferred to be made by mutating serine into cystein on the γ subunit of the F₁-ATPase and binding with the biotin parts of the composition of biotin-strepavidin.

Below one end of the upper rotating arms, a metal pad (e.g. a nickel pole) is preferably mounted. Peptides containing Histidines are then connected with the metal pads. Through the connection of the biotin and the residual binding site of the strepavidin, the upper rotating arm and the rotor of the F₁-ATPase can bind each other firmly. Similarly, on one end of the lower rotating arms, a metal pad is preferably mounted. The metal for metal pad is not limited. Preferably, the metal is gold or nickel for that those materials can bind with Histidines strongly. The F₁-ATPase and the rotor of the upper rotating arms can combine together firmly through the combination of the binding of the biotin terminal and the residual binding sites of the strepavidin.

The size of the molecular motor power-supplying device (100) of the present invention is not limited. If F₁-ATPase is optioned as the molecular motor of this device, preferably, the maximum length of the edge of the molecular motor power-supplying device of the present invention is in a range from 40 nm to 40 μm.

The application of the molecular motor power-supplying device of the present invention is not limited. The molecular motor power-supplying device of the present invention can be applied to any biomedical or micro micrometer systems. One of the examples of the application of the molecular motor power-supplying device of the present invention is the switch or the micro-gate of a drug delivery vehicle. The molecular motor power-supplying device is coupled with a drug delivery vehicle, and the medical ingredients inside the drug delivery vehicle can be released out as the micro gate of the molecular motor power-supplying device is open. In this example, any factor for inhibition the rotation of the molecular motor of the F₁-ATPase can be used as a factor for controlling or maintaining the molecular motor power-supplying device. Preferably, the original state of the molecular motor power-supplying device is maintained or controlled by the zinc cations for inhibiting the rotation of the molecular motor of the F₁-ATPase in the presence of adenosine triphosphate. Similarly, any factor for driving the rotation of the molecular motor of the F₁-ATPase can be used as a factor for recovering the molecular motor power-supplying device. Preferably, the recovery, the drawing back of the micro gate, or the rotation of the molecular motor of the F₁-ATPase is driven by ethyl diamine tetraacetate (EDTA).

The molecular motor power-supplying device of the present invention can transfer the rotation of the molecular motors into linear output power. In other words, the molecular motor power-supplying device changes the output power direction. It can also be applied as a minimized power source for moving in a scale within 10 micrometer. The molecular motor power-supplying device of the present invention can not only amplify the total out power but also increase the output speed. Moreover, the molecular motor power-supplying device of the present invention can be applied as a micro gate with self-driven power.

The following examples offer further description to realize this invention. Besides, the extension of using the micro gate in this invention to develop a drug delivery vehicle is also an example of application.

### EXAMPLE 1

As shown in FIG. 2, the molecular motor (40) is a F₁-ATPase with α subunits (411), β subunits (412), and γ subunit (413). The γ subunit (413) is connected with the nickel pole (42) located on the upper rotating arm (20). The α subunits (411), and the β subunit (412) is connected with the nickel pole (42) located on the lower rotating arm (30).

With reference to FIG. 1, how to realize the simple device, for example, with only two connecting members of this invention will be introduced as below. Before the molecular motor rotates, the angle between the upper rotating arm and the lower rotating arm is initially set a little greater than 120 degrees.

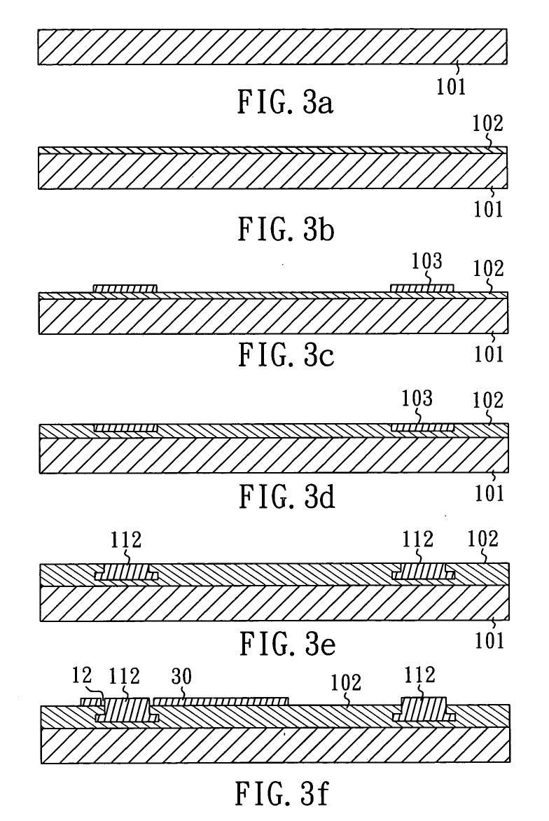

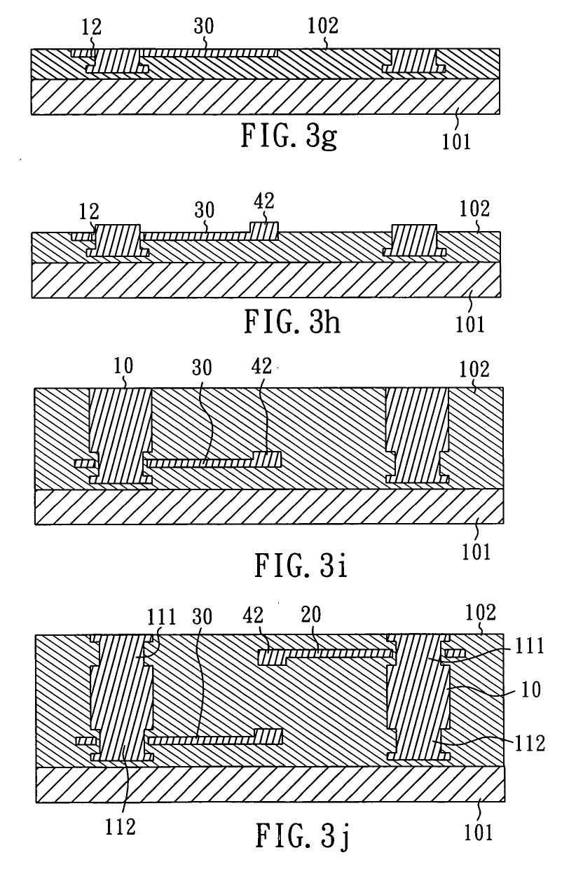

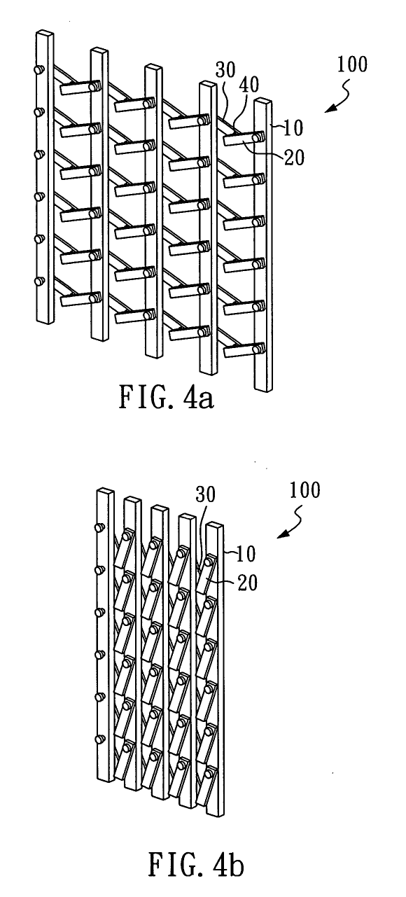

The molecular motor power-supplying device can be made through the process shown in FIG. 3a to 3j. The process is achieved by providing a substrate (101) at first (see FIG. 3a). In the present example, the substrate is a silicon wafer. The substrate (101) is formed a layer of nitride through vcapor deposition to act as a bottom sacrifice layer (102). The bottom sacrifice layer (102) is used to help the release of the elements or layers above them. Two connecting members (10) are formed on the substrate (101) at the same time. Then, a layer of photoresist is coated on the substrate. The photoresist is exposed through electron beam and developed subsequently. A layer of poly silicon (103) is formed through vapor deposition. The photoresist is released to form a patterned layer of poly silicon (103) (see FIG. 3c). The steps illustrated above are repeated to form a structure made of patterned poly silicon (103) and sacrifice layer (101). Similar steps such as photoresist coating, electron beam exposure, development, and etching are repeated to form lower pivots (112) of the connecting member (see FIG. 3e).

Lower rotating arms made of poly silicon are made in the periphery of the lower pivots (112) of the connecting members through the repeated steps illustrated above (see FIG. 3f). As the lower rotating arms are formed, a gap (12) between the lower rotating arms (30) and the lower pivots (112) is formed carefully to make the lower rotating arm rotate freely. The complicate structure containing the lower rotating arms (30), the gap (12) and the sacrifice layer (102) can be formed through the repeated steps illustrated above (see FIG. 3g). Nickel is vapor deposited on one end of the lower rotating arms (30). As shown in FIG. 3h, nickel poles (42) are then formed through the repeated steps. Through repeating steps of photoresist coating, electron beam exposure, development, and etching, structure containing connecting members (10), and sacrifice layer (102) of nitride are formed (see FIG. 3i). Finally, by repeating the steps illustrated above, two connecting members (10) (see FIG. 3j) having upper rotating arms (20) and lower rotating arms (30) can be formed on the substrate (101). Among them, the upper rotating arms connect with the upper pivots (111), and the lower rotating arms connect the lower pivots (112). The basic structure of the molecular motor power-supplying device can be made after the sacrifice layer (102) is etched.

After the basic structure of the molecular motor power-supplying device (100) is completed, the γ subunit and the α, β subunits of the F₁-ATPase should be mounted on the nickel poles (42) of the upper rotating arm (20) and the lower rotating arm (30) respectively. The mounting of the F₁-ATPase on the upper rotating arms is performed through the following steps: At first, the substrate with the basic structure of the molecular motor power-supplying device is inversed and immersed in a buffer solution. Then a peptide (NH2-CGGSGGSHHHHHH-COOH, where C=cysteine, G=glycine, S=serine, and H=histidine) bridged with biotin and cysteins at the two terminals are added into the buffer solution. By the assistance of the gravity, the histidine terminal of the bridged peptide can bind with the metal firmly.

In addition, since the cystein, contained in near the top of the r subunit which is gene engineered, can bind with the biotin through the disulfide bond. If biotin-strepavidin composition is added, thus, the residual binding sites of the strepavidin can bind with the biotin of the bridged peptide. Hence, the F₁-ATPase molecular motors can combine with the upper rotating arm.

The α and β subunits are modified through genetic engineering. After the modification, Histidines are included in the bottom of these subunits. Thus, the F₁-ATPase can securely bind with the nickel pole naturally.

Through the steps illustrated above, the adequate combination between the basic structure of the molecular motor power-supplying device and the F₁-ATPase motor can be obtained.

The α and β subunits of the F₁-ATPase can connect with the nickel pole on the lower rotating arm coupled with some one connecting member. The γ subunit of the F₁-ATPase can connect with another nickel pole on the upper rotating arm coupled with “the other one” connecting members, too. Hence, two connecting members are connected together through the F₁-ATPase motor. The buffer solution used here is pH7 Mops-KOH 50 mM KCl 5 mM MgCl₂ and 1% BSA. After the molecular motors are mounted, the molecular motor power-supplying device is washed with the buffer solution for removing the residual F₁-ATPase. Then by removing the sacrifice layer, the molecular motor power-supplying device of the present example can be obtained.

### EXAMPLE 2

The two terminal (the most left and right) connecting members (10) of the molecular motor power-supplying device (100) obtained in example 1 are connected to an NEMS/MEMS which needs pulling force or pulled closely. The angle between the upper rotating arm (20) and the lower rotating arm (30) is initially set a little greater than 120 degrees before rotation is enabled. As shown in FIGS. 4a and 4b, the molecular motor power-supplying device (100) can be shortened and output power as many molecular motors concerted rotate. As the molecular motors rotate (about 120 degrees), the connecting members move closely. Hence, the connecting members (10) of the molecular motor power-supplying device 100 can be shortened and output power to MEMS/NEMS by the assistance of the rotation of the molecular motors.

### EXAMPLE 3

The molecular motor power-supplying device (100) obtained in example 1 is combined with a drug delivery vehicle(200). As shown in FIG. 5a and 5b, the molecular motor power-supplying device (100) obtained in example 1 can be a micro gate for the drug delivery vehicle (200). The micro gate is closed in FIG. 5a, and is opened in FIG. 5b. As the micro gate is opened, the medical ingredients limited in the drug delivery vehicle (200) can be released out. In the present example, the factor for controlling the movement of the micro gate is the zinc cation and the ethyl diamine tetraacetate (EDTA). The zinc cation can bind with the α and β subunits of F₁-ATPase and inhibit the further change of the conformation of the F₁-ATPase. In other words, zinc inhibits the rotation of F₁-ATPase and it is offered initially in this example. On the other hand, the ethyl diamine tetraacetate (EDTA) can form strong bonding with zinc. In the present example, as the ethyl diamine tetraacetate (EDTA) is added into the solution of zinc where the molecular motor power-supplying device is immersed, the bonding between the zinc and the α, β subunits of F₁-ATPase reduces very quickly. In contrast, the zinc and the ethyl diamine tetraacetate (EDTA) forms stable complex in the solution. Thus, the molecular motor, i.e. the F₁-ATPase, rotates around 120 degrees as F₁-ATPase is hydrolyzed after EDTA being offered. Hence, the micro gate (100) of the drug delivery vehicle opens to release the medical ingredients inside.

Although the present invention has been explained in relation to its preferred embodiment, it is to be understood that many other possible modifications and variations can be made without departing from the spirit and scope of the invention as hereinafter claimed.

What is claimed is:

1. A molecular motor power-supplying device, comprising:
at least two connecting members which are formed with multiple upper pivots and multiple lower pivots on their top and bottom surfaces respectively;
multiple molecular motors having a stator and a rotor which can rotate each other relatively, wherein the molecular motors are located between any two neighboring said connecting members;
multiple upper rotating arms, wherein one end of this upper rotating arm is securely connected to said rotor of said molecular motor, and the other end of this upper rotating arm is pivoted connecting to said upper pivot of said connecting member such that the upper rotating arm can rotate relatively to one of said two neighboring connecting members; and
multiple lower rotating arms, wherein one end of this lower rotating arm is securely connected to said stator of said molecular motor, and the other end of this lower rotating arm is pivoted connecting to said lower pivot of said connecting member such that the lower rotating arm can rotate relatively to the other one of said two neighboring connecting members; thereafter, each two neighboring connecting members can be translated closely or far away according to the concerted rotation between stators and rotors of said molecular motors such that the pulling or pushing forces accumulated from the contributions of many rotating molecular motors can be outputted through the two terminal connecting members and thus a power-supplying device is formed.

2. The molecular motor power-supplying device as claimed in claim 1, wherein the molecular motor is securely connected to the upper rotating arm through a rotor connecting site, and the molecular motor is securely connected to the lower rotating arm through a stator connecting site.

3. The molecular motor power-supplying device as claimed in claim 1, wherein the molecular motor is an F₁-ATPase bio-motor, the α and β subunits are its stator, the γ subunit is its rotor, and the angle between the upper rotating arm and the lower rotating arm connecting to the same molecular motor is initially set a little greater than 120 degree.

4. The molecular motor power-supplying device as claimed in claim 2, wherein the molecular motor is a bio-motor and its stator connecting site or rotor connecting site is made by modification or mutation of gene and gene expression for protein.

5. The molecular motor power-supplying device as claimed in claim 3, wherein the top of the γ subunit of F₁-ATPase is the rotor connecting site and is gene engineered to include the Cysteine amino acid.

6. The molecular motor power-supplying device as claimed in claim 3, wherein the bottom of the α and β subunits of F₁-ATPase are the stator connecting site and are gene engineered to include the Histidine tags.

7. The molecular motor power-supplying device as claimed in claim 3, wherein a metal pad is mounted on one end of the lower rotating arm for connecting the histidines on the stator connecting site.

8. The molecular motor power-supplying device as claimed in claim 7, wherein the metal is gold or nickel.

9. The molecular motor power-supplying device as claimed in claim 1, wherein a metal pad is mounted on one end of the upper rotating arm for connecting the Histidines terminal of a peptide comprising Histidines and biotins terminals.

10. The molecular motor power-supplying device as claimed in claim 9, wherein the metal is gold, copper, nickel, or the alloy thereof.

11. The molecular motor power-supplying device as claimed in claim 1, wherein the molecular motor power-supplying device itself can be used as a micro gate and can be opened and closed by the driving force of molecular motors.

12. The molecular motor power-supplying device as claimed in claim 1, wherein the connecting members are made of metal which can be one metal of aluminum, iron, gold, silver, copper and nickel, or alloys thereof.

13. The molecular motor power-supplying device as claimed in claim 1, wherein the upper rotating arms or the lower rotating arms are made of metal which can be one metal of aluminum, iron, gold, silver, copper and nickel, or alloys thereof.

14. The molecular motor power-supplying device as claimed in claim 1, wherein the connecting members are made of non-metal which can be one material of silicon, poly-silicon, SiO₂, nitride, quartz and polymer, or the combination thereof.

15. The molecular motor power-supplying device as claimed in claim 1, wherein the upper rotating arms or the lower rotating arms are made of non-metal which can be one material of silicon, poly-silicon, SiO₂, nitride, quartz and polymer, or the combination thereof.

16. The molecular motor power-supplying device as claimed in claim 3, wherein the zinc cations are offered initially for inhibition the rotation of the molecular motor of the F₁-ATPase in the presence of adenosine triphosphate (ATP), i.e., to disable this device at initial state, and the ethyl diamine tetraacetate (EDTA) is offered to enable this device.

17. The molecular motor power-supplying device as claimed in claim 3, wherein the molecular motor power-supplying device can also be used as a one-direction micro gate. Once the “closing state” of the gate having initially set, it may be driven to “opening state” by the molecular motors therein.

18. The micro gate as claimed in claim 17, wherein the micro gate is coupled with a drug delivery vehicle, and the medical ingredients inside the drug delivery vehicle can be released out as it is opened.
